(19) United States
(12) Patent Application Publication
(10) Pub. No.: US 2014/0360742 A1
(43) Pub. Date: Dec. 11, 2014

(54) HAND-HELD HOES

(71) Applicant: Bernard Finney, Woodinville, WA (US)

(72) Inventor: Bernard Finney, Woodinville, WA (US)

(21) Appl. No.: 14/192,340

(22) Filed: Feb. 27, 2014

Related U.S. Application Data
(60) Provisional application No. 61/831,962, filed on Jun. 6, 2013.
(60) Provisional application No. 61/859,353, filed on Jul. 29, 2013.

(51) Int. Cl. A01B 1/08

(52) U.S. Cl. CPC A01B 1/08
USPC 172/381; 172/371

(57) ABSTRACT

A hoe includes a handle and a blade. In some embodiments, the handle and the blade are connected via a connection member. The connection member permits flexing, which reduces how much shock is transmitted to the user with digging motions. In some embodiments, the blade includes one or more sections at different angles. The different angles accomplish a gripping effect, which reduces how much the hoe is driven out of the ground, as it is being pulled. Accordingly, fewer interruptions and digging motions are needed to cover an area, which one permits to finish faster. In some embodiments, the blade has a mouth that permits some of the soil to flow through it, as the hoe is being pulled. The flow may reshuffle the soil. Optionally, a tooth protrudes such that it further cuts the flow of the soil.

### CROSS REFERENCE TO RELATED PATENT APPLICATIONS

This patent application claims priority from U.S. Provisional Patent Application Ser. No. 61/831,962, filed on Jun. 6, 2013, the disclosure of which is hereby incorporated by reference for all purposes.

This patent application claims priority from U.S. Provisional Patent Application Ser. No. 61/859,353, filed on Jul. 29, 2013, the disclosure of which is hereby incorporated by reference for all purposes.

### BACKGROUND

A hoe is a tool for use in gardening, such as for breaking up soil. FIG. 1 shows a hoe 100 in the prior art. Hoe 100 has an oblong handle 192 and a blade 198. Blade 198 is typically thin, rectangular, and planar. Blade 198 is oriented such that, if handle 192 were considered to have an axis, that axis would be almost perpendicular to a plane of blade 198.

A user holds handle 192, and then swings it downwards quickly in a digging motion, so that blade 198 digs into the ground by a few inches. The user then pulls, or drags, handle 192 so that a flat side of blade 198 is pulled against the soil to break it up. Accordingly the type of hoe 100 is also called a pull hoe.

There are problems with using a pull hoe. First, as soon as the pulled hoe breaks up a clump of soil, further pulling or dragging results in the hoe being driven out of the ground. To continue hoeing, the user needs to pause, and repeat the downward digging motion, which takes more time.

Second, every time the downward digging motion is indeed repeated, as blade 198 hits the ground, a shock is transmitted via handle 192 into the body of the user. Repetitive shocks can be tiring to the user. Elderly people tending their gardens are even more vulnerable to these repetitive shocks.

### BRIEF SUMMARY

The present description gives instances of improved hoes, the use of which may help overcome problems and limitations of the prior art.

In some embodiments, a hoe includes a handle and a blade, which are connected via a connection member. The connection member permits flexing, which reduces how much shock is transmitted to the user with every digging motion.

In some embodiments, a hoe includes at least a handle and a blade. The blade includes one or more sections at different angles. The different angles accomplish a gripping effect, which reduces how much the hoe is driven out of the ground, as it is being pulled. Accordingly, fewer interruptions and digging motions are needed to cover an area, which one permits to finish faster.

In some embodiments, a hoe includes at least a handle and a blade. The blade has a mouth that permits some of the soil to flow through it, as the hoe is being pulled. The flow may reshuffle the soil. Optionally, a tooth protrudes such that it further cuts the flow of the soil.

These and other features and advantages of this description will become more readily apparent from the following Detailed Description, which proceeds with reference to the drawings, in which:

### BRIEF DESCRIPTION OF THE DRAWINGS

FIG. 1 is a perspective view of a hoe in the prior art.

FIG. 2 is a conceptual side view of a soft dig pull hoe made according to embodiments.

FIG. 3 is a top view of a steel spring embodiment of a connection member that can be the connection member in the embodiment of FIG. 2.

FIG. 4 is a side view illustrating an embodiment of how an end of a steel spring can be attached to a distal end of a handle, such as the handle of FIG. 2.

FIG. 5 is a side view illustrating an embodiment of how an end of the steel spring of FIG. 3 can be attached to an end of a hoe blade such as the hoe blade of FIG. 2.

FIG. 6 is a perspective view of a coil spring embodiment of a connection member of the embodiment of FIG. 2.

FIG. 7 is a side view illustrating an embodiment of how the coil spring of FIG. 6 can be attached to a handle and to a hoe blade such as the handle and the hoe blade of FIG. 2.

FIG. 8A is a perspective view of an earth-gripping pull hoe made according to embodiments.

FIG. 8B is a side view of salient aspects of the hoe of FIG. 8A for illustrating the concept of a griping angle according to embodiments.

FIG. 8C is a side view of salient aspects of a hoe with a bent working portion according to embodiments.

FIG. 9 is a perspective view of an earth-gripping hoe with a mouth made according to embodiments.

FIG. 10 is a perspective view of a hoe with a mouth and a tooth made according to embodiments.

FIG. 11 is a view of a projected perimeter of a mouth of the hoe of FIG. 10 in a plane perpendicular to an axis of a handle of the hoe of FIG. 10, further illustrating a geometric property arising from a tooth feature according to embodiments.

FIG. 12 is a perspective view of a section of an earth-gripping hoe with a mouth and a tooth made according to embodiments.

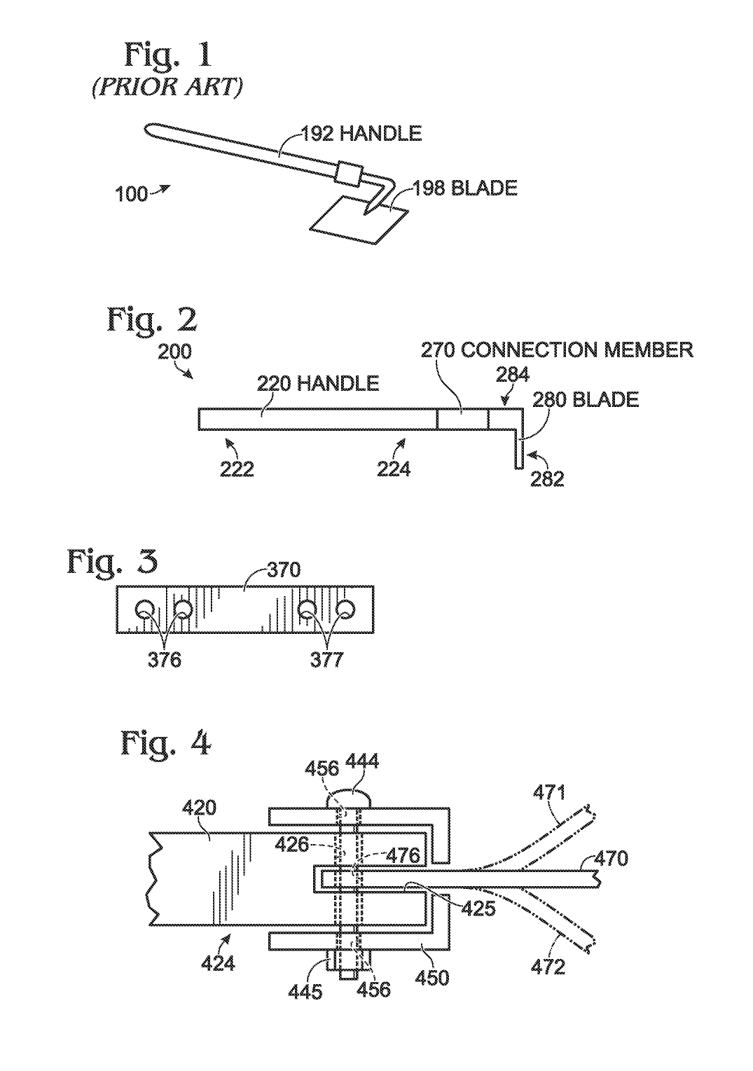

### DETAILED DESCRIPTION

As has been mentioned, the present description is about improvements in pull hoes. Embodiments are now described in more detail.

FIG. 2 is a conceptual side view of a hoe 200 made according to embodiments. Hoe 200 is configured for a user to hoe soil, such as in a garden. An embodiment of a hoe based on FIG. 2 can also be called a soft dig pull hoe.

Hoe 200 includes a handle 220. Handle 220 has a user end 222 that is configured to be grasped by the user. Handle 220 also has a distal end 224.

Handle 220 has an overall length that can take any dimension. In some embodiments the length is less than 2′, for use primarily when kneeling. In other embodiments, the length is over 3′, for use primarily when standing up.

Distal end 224, and possibly entire handle 220, is made from at least a first material, such as wood, plastic metal and so on, or a combination of the first material with another material. The first material has a first consistency, for example as can be manifested by macroscopic properties of distal end 224. For example, different types of wood have different consistencies, depending on the wood itself. Further, different types of metal have different consistencies, and so on.

Hoe 200 also includes a connection member 270. Embodiments of connection member 270 are described in more detail later in this document. Connection member 270 is directly attached to distal end 224, or is coupled to it, for example via one or more additional components.

Connection member 270 can be made from at least a second material that has a second consistency. Typical candidates for the second material include steel, as will be seen in more detail below. The second consistency can be different from the first consistency of distal end 224. For example, even if both connection member 270 and distal end 224 were made out of steel, they could differ in macroscopic properties such as tensile strength, and so on.

Hoe 200 moreover includes a blade 280. Blade 280 has a working portion 282 that is configured to contact the soil. Working portion 282 can be made as is known in the art, or as in further embodiments. Blade 280 also has an attachment portion 284. Attachment portion 284 is directly attached to connection member 270, or is coupled to it, for example via one or more additional components.

Attachment portion 284, and possibly entire blade 280, can be made from at least a third material. The third material can be steel or other material hard enough to dig into the ground, upon impact. The third material has a third consistency, which can be different from the second consistency of connection member 270. For example, even if both connection member 270 and attachment portion 284 were made out of steel, they could differ in macroscopic properties such as tensile strength, and so on. In particular, the second material could be more easily flexible than the third material. Because of the flexibility, the impact transmitted from blade 280 to handle 220 can be reduced.

FIG. 2 is conceptual, and not limiting. For example, connection member 270 is shown simply next to handle 220 and blade 280, without showing the manner of coupling of attachment. Sample such manners will be described later in this document.

FIG. 3 is a top view of a steel spring 370. Steel spring 370 can be used as connection member 270 in FIG. 2. Steel spring 370 can optionally include one or more steel spring holes 376, 377, for attachment as will be seen later in this document.

Steel spring 370 can be flexible and resilient. The flexibility is what reduces the impact transmitted to the user, while the resilience permits the original shape to be restored. After some experimentation, good dimensions for steel spring 370 were found to be as follows:

Thickness ⅛″. The thickness is perpendicular to the drawing of FIG. 3.

Width: 1¼″. The width is seen as height, i.e. the short dimension, in FIG. 3.

Length: 7″. The length is the long dimension in FIG. 3.

Steel spring holes 376, 377 can be large enough to allow a ¼″ bolt through them.

A steel spring can be attached to a handle in a number of ways. An example follows.

FIG. 4 shows a portion of a handle 420, which could be as handle 220. Handle 420 has a distal end 424, which could be as distal end 224. Handle 420 has a handle opening 425 at distal end 424.

A side view of a steel spring 470 is shown, which could have similarities with steel spring 370. Steel spring 470 is partly received in handle opening 425. Accordingly, steel spring 470 can flex, thus being able to occupy positions such as positions 471, 472. Positions 471, 472 are shown spaced widely, for clarity. In reality, while steel spring 470 might flex, it might not flex as widely as positions 471, 472 suggest.

In some embodiments, handle 420 has at least one handle hole 426. Where, as here, handle hole 426 encounters handle opening 425, handle hole 426 may extend past handle opening 425 until it exits handle 420.

Steel spring 470 has at least one steel spring hole 476. In addition, the hoe would further include a bolt 444, inserted through handle hole 426 and steel spring hole 476. Bolt 444 can be approximately ¼″ diameter.

Moreover, a nut 445 can be screwed on to bolt 444. After screwing, nut 445 can become more permanently attached to bolt 444, for example by soldering.

FIG. 4 shows only a single set of a handle hole 426, steel spring hole 476, bolt 444 and nut 445, but that is only for clarity. In reality, two sets could be used, and so on. For example, steel spring 370 has two steel spring holes 376, both of which would be inserted in a handle opening.

A challenge is that, implementing handle opening 425 and handle hole 426 removes material from distal end 424, to which stresses will be applied by steel spring 470 from the digging motion. To preserve the structural integrity of distal end 424 in the face of such stresses, embodiments of a hoe could further include a metal pipe section 450. Pipe section 450 can surround at least a portion of distal end 424. As such, pipe section 450 would also surround at least a portion of steel spring 470 that is received within handle opening 425.

In FIG. 4, pipe section 450 reaches, from the sides of handle 420, up to steel spring 470. Such is preferred but not necessary.

Where bolts are used, pipe section 450 can accommodate. For example, it could have one or more pipe holes 456, and bolt 444 can be inserted through one or more pipe holes 456 in addition to the other holes mentioned above.

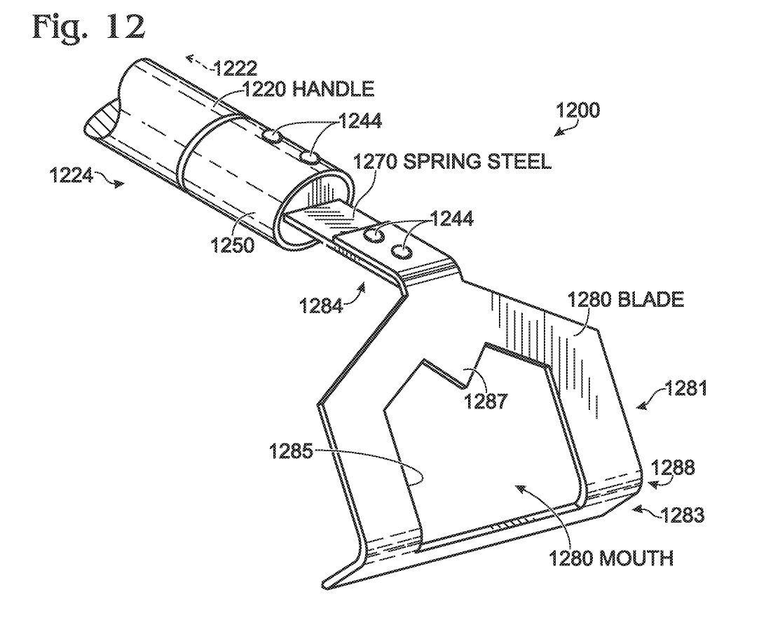

Pipe section 450 will necessarily have some thickness above and beyond the thickness of handle 420. That may be not aesthetically nice, plus it may pose a slight hazard to the user. Accordingly, in some embodiments, pipe section 450 has the same diameter as handle 420 and is flush with it. For manufacture, a portion of distal end 424 can be beveled down before pipe section 450 is applied, as will be seen later in FIG. 12.

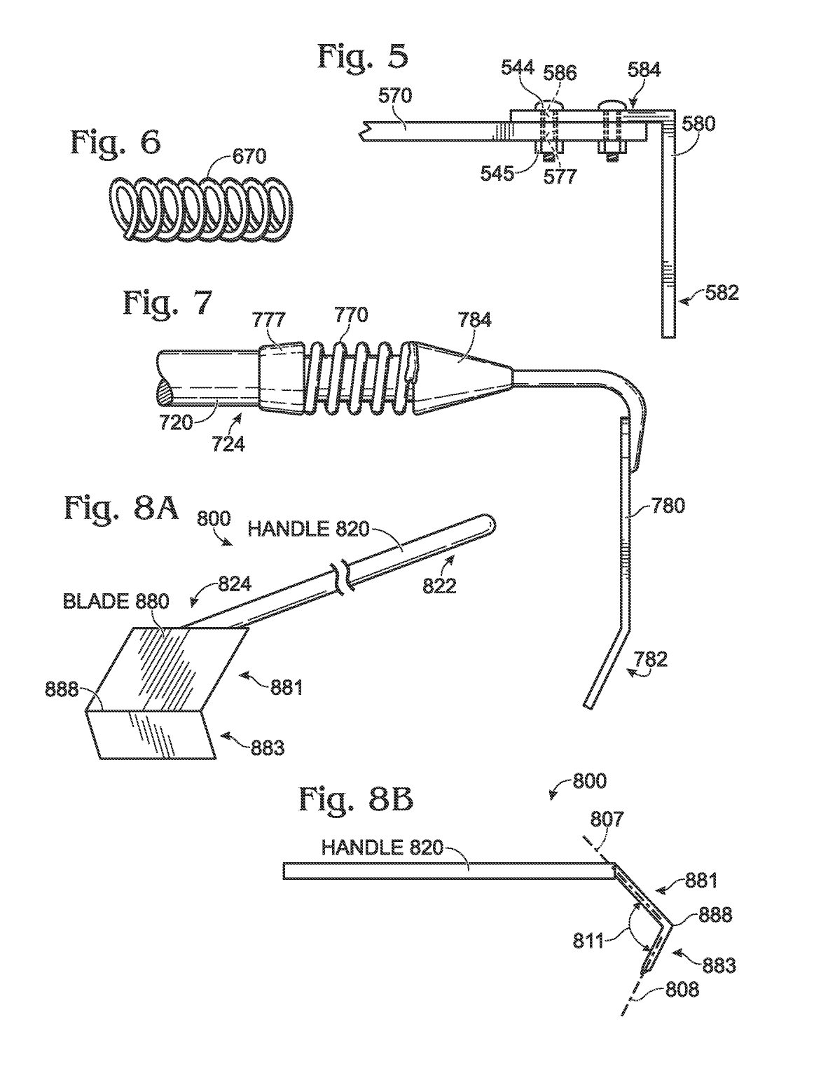

FIG. 5 shows a blade 580, which could be as blade 280. Blade 580 has a working portion 582, which could be as working portion 282. Blade 580 also has an attachment portion 584, which could be as attachment portion 284. Attachment portion 584 has at least one, here two, attachment holes 586, of which only one is indicated so as not to clutter the drawing.

A side view of a steel spring 570 is shown, which could have similarities with steel springs 370 and 470. Steel spring 570 has at least one, here two steel spring holes 577, of which only one is indicated so as not to clutter the drawing.

A hoe made as in FIG. 5 also includes at least one bolt 544; in fact, there are two, of which only one is indicated. The indicated bolt 544 is inserted through attachment hole 586 and steel spring hole 577. Moreover, a nut 545 can be screwed on to bolt 544, similarly to what was described above.

FIG. 6 is a perspective view of a coil spring 670. In embodiments, coil spring 670 serves as connection member 270 of FIG. 2. An example is now described.

FIG. 7 shows a portion of a handle 720, which could be as handle 220. Handle 720 has a distal end 724, which could be as distal end 224.

A side view of a coil spring 770 is shown, which could have similarities with coil spring 670. Coil spring 670 is attached to distal end 724 via a joint 777, which can be made of steel. Accordingly, coil spring 770 can flex, to absorb shock.

In the embodiment of FIG. 7, a portion of distal end 724 actually internally extends within a portion of coil spring 770. The dimensions are such that the desirable amount of flexing is permitted. This internal extending is not necessary to practice the invention, and joint 777 can alternately be located more to the right in other embodiments, than is shown in FIG. 7.

FIG. 7 shows a blade 780, which could be as blade 280. Blade 780 has a working portion 782, which could be as working portion 282. Blade 780 also has an attachment portion 784, which is soldered to spring 770.

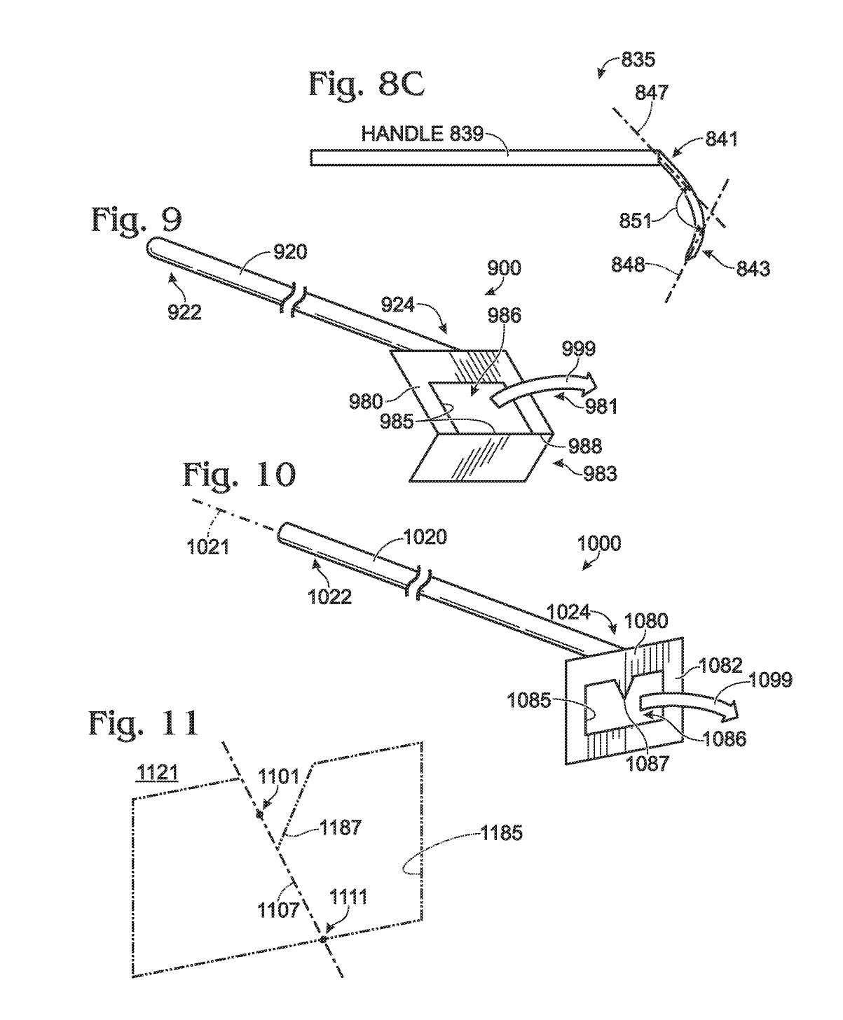

FIG. 8A is a perspective view of a hoe 800 made according to embodiments. An embodiment of a hoe based on hoe 800 can also be called an earth-gripping pull hoe.

Hoe 800 includes a handle 820, which could be as handle 220. Handle 820 has a user end 822, which can be configured to be grasped by a user, as user end 222. Handle 820 also has a distal end 824, which could be as distal end 224.

Hoe 800 also includes a blade 880. Blade 880 has an attachment portion, which is not indicated separately. The attachment portion is coupled to distal end 824, which can be implemented in many ways. For example, the attachment portion can be attached to distal end 824. Or a connection member can be coupled between the distal end and the attachment portion, as described above, starting from FIG. 2.

Blade 880 further has a working portion configured to contact the soil, and which is not indicated individually. The working portion includes at least a first section 881, and a second section 883 that is at a gripping angle from first section 881. The gripping angle occurs because, equivalently, sections 881 and 883 are at different angles with respect to a portion of hoe 800, such as, for example handle 820.

The gripping angle can be implemented by starting with a single metal segment and bending it. The gripping angle can be defined from sides of the working portion that face handle 820, which would be the inward side of the bending and therefore have a value of less than 180°. The outward side of the bending would therefore have a value larger than 180°. Of course, a value of 180° would correspond to no bending at all.

The gripping angle can have the result that hoe 800 is not driven out of the earth, upon breaking up a clump of soil in front of the blade 880. Rather, section 883 tends to remain dug in the soil, thanks to the gripping angle. For embodiments such as that of FIG. 8A, the gripping angle can have a value of less than 170°. A good value is approximately 135°.

Referring briefly to FIG. 8B, the concept of the gripping angle is now explained in more detail. In the example of FIGS. 8A and 8B, sections 881, 883 are large enough to include practically the entire working portion. Moreover, sections 881, 883 are substantially flat, and the entire transition from section 881 to section 883 takes place along a spine 888, which can thus be a crease, or a fold in the single metal segment. In that case, section 881 lies along line 807 and section 883 lies along line 808. Gripping angle 811 can be defined as shown, as the angle subtended between lines 807 and 808, and from sides of the working portion that face handle 820.

In other embodiments, sections 881, 883 need not be large enough to include the entire working portion. They can be infinitesimally narrow, while the working portion is bent, and far from each other along the working portion. An example is now described.

FIG. 8C is a side view of salient aspects of a hoe 835 with a handle 839 and a working portion that is bent. A first section 841 is infinitesimally small, near handle 839, and is on a plane, or has a tangent along line 847. A second section 843 is infinitesimally small, near the end that digs, and is on a plane or has a tangent along line 848. The transition from first section 841 to second section 843 takes place rather gradually. Gripping angle 851 is defined from lines 847, 848, and from sides of the working portion that face handle 839.

FIG. 9 is a perspective view of an earth-gripping hoe 900. Hoe 900 includes a handle 920, which could be as handle 220. Handle 920 has a user end 922, which can be configured to be grasped by a user, as user end 222. Handle 920 also has a distal end 924, which could be as distal end 224.

Hoe 900 also includes a blade 980. Blade 980 has an attachment portion, which is not indicated separately. The attachment portion can be coupled to distal end 924. This coupling can be implemented in many ways. For example, the attachment portion can be attached to distal end 924. Or a connection member can be coupled between the distal end and the attachment portion, as described above, starting from FIG. 2.

Blade 980 also has a working portion that is configured to contact the soil, and which is not indicated separately so as to not clutter the drawing. The working portion has sections 981, 983, which are joined at a spine 988.

The working portion also has a mouth 986 according to embodiments. For purposes of this description, a mouth is an opening in the working portion of a hoe's blade. A mouth can be made by a cutout in the working portion. Mouth 986 is bounded by a perimeter 985, of which only two sides are indicated.

Mouth 986 is configured to allow the soil to flow therethrough, according to a flow 999, when blade 980 is in the soil and the user pulls handle 920. Accordingly, mouth 986 reduces the resistance the user faces when using an earth-gripping hoe such as hoe 900.

In the particular case of FIG. 9, at least a portion of perimeter 985 is coextensive with spine 988. This has the benefit of reducing resistance, given that section 983 can remain dug in the earth. It is not necessary however that a mouth be implemented that way, or even in only one of sections 981, 983. In fact, a mouth can be implemented according to embodiments where a hoe is not earth-gripping. An example is now described.

FIG. 10 is a perspective view of a hoe 1000 made according to embodiments. Hoe 1000 includes a handle 1020, which could be as handle 220. Handle 1020 has a user end 1022, which can be configured to be grasped by a user, as user end 222. Handle 1020 also has a distal end 1024, which could be as distal end 224.

Hoe 1000 also includes a blade 1080. Blade 1080 has an attachment portion, which is not indicated separately. The attachment portion can be coupled to distal end 1024. Coupling can be implemented in many ways. For example, the attachment portion can be attached to distal end 1024. Or a connection member can be coupled between the distal end and the attachment portion, as described above, starting from FIG. 2.

Blade 1080 also has a working portion 1082, which is configured to contact the soil. Working portion 1082 can be flat, or bent as described above.

Working portion 1082 also has a mouth 1086, which is bounded by a perimeter 1085. Mouth 1086 is configured to allow the soil to flow therethrough, according to a flow 1099, when blade 1080 is in the soil and the user pulls handle 1020 from user end 1022.

Working portion 1082 further has an optional tooth 1087. Tooth 1087 can protrude such that the soil flowing through mouth 1086, according to flow 1099, is cut by tooth 1087. Cutting would be from the top, given the position of the tooth. The tooth can also be in other positions. Cutting can condition the soil better. Optionally and preferably, tooth 1087 terminates at a sharp point, for cutting better the flow 1099 of flowing soil. Moreover, the working portion could include further one or more teeth, and so on.

In the embodiment of FIG. 10, tooth 1087 is a feature of perimeter 1085 by which mouth 1086 is bounded. In such cases, the tooth can be implemented economically by proper design of the perimeter. In other embodiments, a tooth can be implemented by attaching a nail or equivalent structure next to the mouth.

Features of a tooth are now described more rigorously, so as to prevent confusion. If a mouth were merely rectangular or circular, no feature would protrude towards the flow of soil, so as to cut it. A tooth, however, protrudes that way.

In the embodiment of FIG. 10 handle 1020 is oblong. In fact, it is often a rod. Handle 1020 defines a handle axis 1021 along its length.

FIG. 11 shows a geometric plane 1121. Plane 1121 is perpendicular to handle axis 1021 of FIG. 10. FIG. 11 shows projected perimeter 1185, which results from projecting entire perimeter 1085 onto plane 1121. From this projection, tooth feature 1087 becomes projected tooth feature 1187. A point 1101 in tooth feature 1187 is a place where tooth feature 1087 has becomes projected. A test line 1107 has the attributes that it is within plane 1121, and is tangent to projected perimeter 1185 at point 1101.

In some embodiments, a test line with the attributes of test line 1107 intersects projected perimeter 1185 at one more point 1111 where tooth feature 1087 is not projected. The specific attribute arises because projected tooth feature 1187 protrudes towards the center of projected perimeter 1185. It will be appreciated that this would not happen if projected perimeter 1185 were circular or oval—in such cases a test line would leave the entire projected perimeter on its one or other side. A tangent is not defined where projected perimeter 1185 is a point.

FIG. 12 is a perspective view of a section of an earth-gripping hoe 1200, made according to embodiments. Hoe 1200 includes a handle 1220, which could be as handle 220. Handle 1220 has a user end 1222, which is not shown. Handle 1220 also has a distal end 1224, which could be as distal end 224.

Hoe 1200 includes a pipe section 1250, which could be as pipe section 450. A portion of distal end 1224 has been beveled down, so that the outer surface of pipe section 1250 is flush with handle 1220.

Hoe 1200 also includes a steel spring 1270, which can be made as described above, with reference to steel spring 370. Steel spring 1270 can be inserted in a handle opening of handle 1220 that is under pipe section 1250 and not visible, but similar to what was described above with reference to FIG. 4. Steel spring 1270 is retained attached to handle 1220 via bolts 1244 that go through pipe section 1250.

Hoe 1200 further includes a blade 1280. It will be appreciated that blade 1280 can be made from a single sheet of steel, properly bent and cut.

Blade 1280 has an attachment portion 1284. Attachment portion 1284 is attached to steel spring 1270 via additional bolts 1244.

Blade 1280 also has a working portion, which is not indicated separately. The working portion includes a first section 1281, and a second section 1283 that is at a gripping angle from first section 1281. The entire transition from first section 1281 to second section 1283 takes place along a spine 1288. The working portion also has a mouth 1286, which is bounded by a perimeter 1285. The working portion further has a tooth 1287 within mouth 1286.

This description includes one or more examples, but that does not limit how the invention may be practiced. Indeed, examples or embodiments of the invention may be practiced according to what is described, or yet differently, and also in conjunction with other present or future technologies.

Reference to any prior art in this specification is not, and should not be taken as, an acknowledgement or any form of suggestion that this prior art forms parts of the common general knowledge in any country.

A person skilled in the art will be able to practice the present invention in view of this description, which is to be taken as a whole. Details have been included to provide a thorough understanding. In other instances, well-known aspects have not been described, in order to not obscure unnecessarily the present invention.

Other embodiments include combinations and sub-combinations of features described herein, including for example, embodiments that are equivalent to: providing or applying a feature in a different order than in a described embodiment; extracting an individual feature from one embodiment and inserting such feature into another embodiment; removing one or more features from an embodiment; or both removing a feature from an embodiment and adding a feature extracted from another embodiment, while providing the advantages of the features incorporated in such combinations and sub-combinations.

The following claims define certain combinations and subcombinations of elements, features and steps or operations, which are regarded as novel and non-obvious. Additional claims for other such combinations and subcombinations may be presented in this or a related document.

1. A hoe configured for a user to hoe soil, comprising:
a handle having a user end configured to be grasped by the user and a distal end, the distal end made from at least a first material that has a first consistency;
a connection member coupled to the distal end, the connection member made from at least a second material that has a second consistency different from the first consistency; and
a blade having a working portion configured to contact the soil and an attachment portion coupled to the connection member, the attachment portion made from at least a third material that has a third consistency different from the second consistency.

2. The hoe of claim 1, in which
the second material is more easily flexible than the third material.

3. The hoe of claim 1, in which
the connection member includes a steel spring.

4. The hoe of claim 1, in which
the handle has a handle opening at the distal end, and
the steel spring is partly received in the handle opening.

5. The hoe of claim 1, in which
the handle has at least one handle hole,
the steel spring has at least one steel spring hole, and
further comprising: a bolt inserted through the handle hole and the steel spring hole.

6. The hoe of claim 5, further comprising:
a nut screwed on to the bolt.

7. The hoe of claim 1, further comprising:
a metal pipe section surrounding at least a portion of the distal end.

8. The hoe of claim 7, in which
the handle has at least one handle hole,
the steel spring has at least one steel spring hole,
the metal pipe section has one or more pipe holes, and
further comprising: a bolt inserted through the handle hole, the steel spring hole and the one or more pipe holes.

9. The hoe of claim 8, further comprising:
a nut screwed on to the bolt.

10. The hoe of claim 1, in which
the attachment portion has at least one attachment hole,
the steel spring has at least one steel spring hole, and
further comprising: a bolt inserted through the attachment hole and the steel spring hole.

11. The hoe of claim 10, further comprising:
a nut screwed on to the bolt.

12. The hoe of claim 1, in which
the connection member includes a spring coil.

13. The hoe of claim 12, in which
a portion of the distal end internally extends within the spring coil.

14. A hoe configured for a user to hoe soil, comprising:
a handle having a user end configured to be grasped by the user and a distal end; and
a blade having an attachment portion coupled to the distal end and a working portion configured to contact the soil, the working portion having a first section and a second section at a gripping angle from the first section, the gripping angle defined from sides of the working portion facing the handle and having a value of less than 170°.

15. The hoe of claim 14, in which
the attachment portion is attached directly to the distal end.

16. The hoe of claim 14, in which
the distal end is made from at least a first material that has a first consistency,
the attachment portion is made from at least a third material that has a third consistency, and
further comprising: a connection member coupled between the distal end and the attachment portion, the connection member made from at least a second material that has a second consistency different from the first consistency and the third consistency.

17. The hoe of claim 16, in which
the second material is more easily flexible than the third material.

18-27. (canceled)

28. A hoe configured for a user to hoe soil, comprising:
a handle having a user end configured to be grasped by the user and a distal end; and
a blade having an attachment portion coupled to the distal end and a working portion configured to contact the soil, the working portion having a mouth configured to allow the soil to flow therethrough when the blade is in the soil and the user pulls the handle, the working portion further having a tooth protruding such that the flowing soil is cut by the tooth.

29. The hoe of claim 28, in which
the attachment portion is attached directly to the distal end.

30. The hoe of claim 28, further comprising:
the distal end is made from at least a first material that has a first consistency,
the attachment portion is made from at least a third material that has a third consistency, and
further comprising: a connection member coupled between the distal end and the attachment portion, the connection member made from at least a second material that has a second consistency different from the first consistency and the third consistency.

31-36. (canceled)
